(19) United States
(12) Patent Application Publication
(10) Pub. No.: US 2016/0029674 A1
(43) Pub. Date: Feb. 4, 2016

(54) RICING SYSTEM WITH SLOTTED RICER PLATE AND METHOD

(71) Applicant: J.R. Simplot Company, Boise, ID (US)

(72) Inventors: David Bruce Walker, Meridian, ID (US); Mike Hamann, Caldwell, ID (US); James Englar, Nampa, ID (US)

(21) Appl. No.: 14/811,449

(22) Filed: Jul. 28, 2015

Related U.S. Application Data
(60) Provisional application No. 62/030,478, filed on Jul. 29, 2014.

(51) Int. Cl. A23L 1/216; B02C 18/36; A23N 15/00

(52) U.S. Cl. CPC A23L 1/2161; A23N 15/00; B02C 18/365; A23V 2002/00

(57) ABSTRACT

A ricer plate for use in a ricing system configured for forcing cooked potato pieces, including potato peel and potato starch, against and through the ricer plate, includes a plate, having a thickness, a center and a perimeter. A plurality of substantially linear, elongate slots are disposed in the plate, extending through the thickness of the plate. Each slot is aligned at an angle relative to a radial line extending from the center, and has a width of at least about 1/10 inch and a length that is at least about three times the width. The slots are suitably shaped to pass a portion of potato peel with the potato starch.

### CROSS-REFERENCE TO RELATED APPLICATIONS

This application, under 35 U.S.C. §119, claims the benefit of U.S. Provisional Patent Application Ser. No. 62/030,478 filed on Jul. 29, 2014, and entitled “SLOTTED RICER PLATE,” the contents of which are hereby incorporated by reference herein.

### FIELD OF THE DISCLOSURE

The present disclosure generally relates to commercial food processing systems and methods. More particularly, the present disclosure relates to a slotted ricer plate for use in a ricing machine for producing mashed potatoes with peel chunks.

### BACKGROUND

Mashed potatoes are commercially produced in high volumes, and are frequently preserved by dehydration (e.g. as potato flakes or granules), or by chilling (for most retail mash products), or by freezing (common for food service). The commercial scale processes for producing all of these types of mashed potato products typically involve a ricing step. Ricing is a common industrial process used in making mashed potatoes. A ricer is a machine that forces cooked potato pieces through a flat ricer plate having a number of small holes. The ricer drives the potatoes through the holes in the ricer plate to impart shear and break up the potato chunks, producing potato mash.

Ricer plates with various hole sizes are available. Smaller holes produce smoother, less chunky mash. Smooth mash that is free of chunks is particularly desirable in producing dehydrated mash because chunks dehydrate relatively slowly in the factory and rehydrate relatively slowly in end use.

Sometimes it is desirable to have small pieces of potato peel included in potato mash. For example, in recent years “homestyle” mashed potatoes that include bits of potato peel have grown in popularity because they are reminiscent of homemade mashed potatoes and because the chunks of potato peel are perceived as adding nutrients. Unfortunately, commercial production of this type of mashed potatoes presents a challenge in the ricer. Mash that includes any significant quantity of potato peel is very difficult to run through a ricer because the peel tends to plug the holes in the ricer plate. A ricer plate hole size that is suitable for producing reasonably smooth mash is generally smaller than the desired peel size for “homestyle” mashed potatoes. Moreover, generally flat pieces of peel are typically too thin to be pressed through the holes in the ricer plate by the internal parts of the ricer. Consequently, the peel pieces tend to plug the holes in the ricer plate, and as the holes plug, throughput decreases, pressure inside the ricing machine increases, and the ricing machine tends to overwork the potato mash, which can adversely affect its texture.

The problem of a ricer plate plugging has typically been solved by frequently removing the ricer plate and either scraping it or turning it over. Unfortunately, this introduces downtime into the process, and involves either manual labor or complex automation.

The present disclosure is directed toward one or more of the above-mentioned issues.

### SUMMARY

It has been recognized that it would be advantageous to have a ricing system that can reliably produce potato mash with potato peel chunks, without introducing problems of clogging and jamming.

In accordance with one aspect thereof, the present disclosure provides a ricer plate for use in a ricing system configured for forcing cooked potato pieces, including potato peel and potato starch, against and through the ricer plate. The ricer plate includes a plate, having a thickness, a center and a perimeter. A plurality of substantially linear, elongate slots are disposed in the plate, extending through the thickness of the plate. Each slot is aligned at an angle relative to a radial line extending from the center, and has a width of at least about 1/10 inch and a length that is at least about three times the width. The slots are suitably shaped to pass a portion of potato peel with the potato starch. The angle of the slots relative to the radial line can be from 0° to 90°. More specifically, the angle α can range from 9° to 45°; from 8° to 45°; from 7° to 45°; from 6° to 45°; from 5° to 45°; from 9° to 50°; from 8° to 50°; from 7° to 50°; and from 6° to 50°; and more particularly from 10° to 45°. In one embodiment, the angle of the slots relative to the radial line is from 10° to 45°.

In accordance with another aspect thereof, the present disclosure provides a ricing system. The ricing system generally includes a ricing machine and a ricer plate. The ricing machine has a distal end, a proximal end with an inlet, and a pumping mechanism disposed between the proximal end and the distal end. The inlet is configured to receive potato pieces including potato starch and potato peel, and the pumping mechanism is configured to force the potato pieces to discharge through the distal end. The ricer plate is disposed at the distal end, has having an inside surface and an outside surface, a center, a perimeter, and a plurality of substantially linear, elongate slots, extending from the inside surface to the outside surface. Each slot is aligned at an angle relative to a radial line extending from the center, and has a width of at least about 1/10 inch and a length that is at least about three times the width. The elongate slots simultaneously pass the potato peel and convert the potato starch substantially to potato mash under pressure from the pumping mechanism. In one embodiment, the angle of the slots relative to the radial line can be from 0° to 90°. More specifically, the angle α can range from 9° to 45°; from 8° to 45°; from 7° to 45°; from 6° to 45°; from 5° to 45°; from 9° to 50°; from 8° to 50°; from 7° to 50°; and from 6° to 50°; and more particularly from 10° to 45°. In one embodiment, the angle of the slots relative to the radial line is from 10° to 45°.

In accordance with another aspect thereof, the present disclosure provides a method for producing potato mash with potato peel. The method includes pressing cooked potato pieces, including potato starch and potato peel, through a plurality of substantially linear, elongate slots of a ricer plate. The slots are aligned at an angle relative to a radial line extending from a center of the ricer plate, and have a width of at least about 1/10 inch and a length that is at least about three times the width. The slots substantially mash the potato starch and pass the potato peel with the potato starch.

### BRIEF DESCRIPTION OF THE DRAWINGS

FIG. 1A is a schematic diagram of one embodiment of a mashed potato processing system including a horizontally oriented ricing machine.

1B is a schematic diagram of another embodiment of a mashed potato processing system including a vertically oriented ricing machine.

FIG. 2 is a perspective view of an embodiment of a ricing machine for producing mashed potatoes.

FIG. 3 is a top view of the ricing machine of FIG. 2.

FIG. 4 is a right side view of the ricing machine of FIG. 2.

FIG. 5 is a plan view of a prior art ricer plate having circular openings.

FIG. 6 is a plan view of one embodiment of a slotted ricer plate in accordance with the present disclosure.

FIG. 7 is a plan view of another embodiment of a slotted ricer plate in accordance with the present disclosure.

FIG. 8 is a perspective view of a distal end of a ricing machine with the ricer plate removed, showing the scraper blades at the distal end of the auger.

FIG. 9 is a perspective view of a distal end of a ricing machine, showing a cutoff wheel positioned near the outside surface of the ricer plate.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

As noted above, “homestyle” mashed potatoes that include bits of potato peel have grown in popularity in recent years. However, the commercial production of mashed potatoes that include any significant quantity of potato peel presents certain challenges. Mashed potatoes are typically produced on a commercial scale using a ricing machine. A ricing machine forces cooked potato pieces through a flat plate having a number of small holes. The ricer drives the potatoes through holes in the ricer plate to impart shear and break up the potato chunks, producing potato mash. Unfortunately, potato peel tends to quickly plug the ricer plate holes of conventional ricing systems.

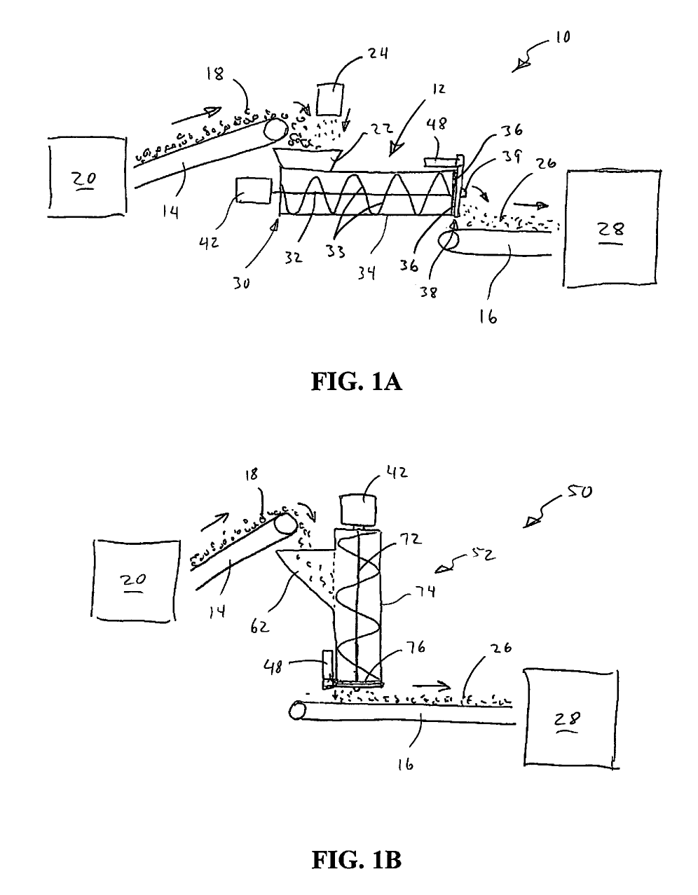

Advantageously, as disclosed herein, a ricing system and method have been developed that can reliably produce potato mash with potato peel chunks, without introducing problems of clogging and jamming. This ricing system employs a slotted ricer plate, which greatly facilitates the production of mashed potatoes with peel chunks. Shown in FIG. 1A is an embodiment of a ricing system 10 that can employ a slotted ricer plate in accordance with the present disclosure. The ricing system 10 generally includes a ricer or ricing machine 12, which is positioned downstream of a product feed device 14, such as a first conveyor, and upstream of a product discharge device 16, such as a second conveyor. It will be apparent that devices other than conveyors can be used for the product feed and discharge devices.

The product feed device 14 brings unmashed product 18 from an upstream processing system, indicated generally at 20, and discharges the product into an inlet 22 of the ricing machine. The unmashed product 18 generally comprises potato chunks with peel, thus including potato starch and potato peel, which have typically been cooked or partially cooked prior to conveyance to the ricer 12, such as by blanching. The potato chunks typically will have a size in the range of 0.25″ to 0.75″. The upstream processing system 20 can include various systems for preparing the potato chunks, such as a potato dicer and a blancher (not shown). Other devices can also be incorporated into the upstream processing system 20. A flavor ingredient dispenser 24 can also be provided to add flavor ingredients (e.g. in powder or granular form) to the unmashed product 18 as it is discharged into the inlet 22 of the ricing machine 12. In this way, flavor ingredients (e.g. herbs, spices, flavorings, etc.) can be mixed into the mashed potatoes by the ricer 12. Flavor ingredients can also be added in other ways and at other points in the process.

The product discharge device 16 is located downstream of the ricer 12, and delivers the mashed product 26 to one or more downstream processing devices, indicated generally at 28. These downstream processing devices can include a dehydrator, a freezer, a mixer or blender to mix in flavoring ingredients, and a packaging device, for example. The various downstream processing devices can be used in various ways and in various sequences to provide the product in one of many desired configurations. For example, peel-in mashed potatoes can be made in dehydrated, refrigerated, and frozen formats. This ricer system 10 can be used to produce any of these product formats, each format using a different combination of downstream processing devices 20. For example, as a first option, the downstream processing devices 20 can be used to first dehydrate, then (optionally) blend in flavoring ingredients, then package the product. Alternatively, the downstream processing devices 20 can be used to first freeze, then dehydrate, then (optionally) blend in flavoring ingredients, then package. As another alternative, the downstream processing devices 20 can first blend in flavoring ingredients, then package, then refrigerate or freeze. Other downstream processing devices and processes can also be used.

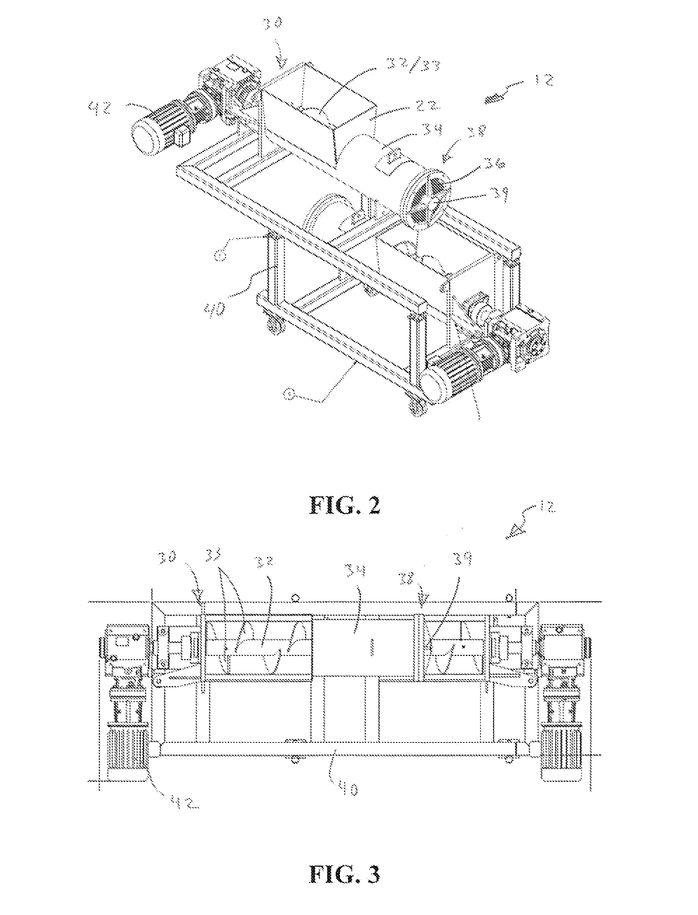

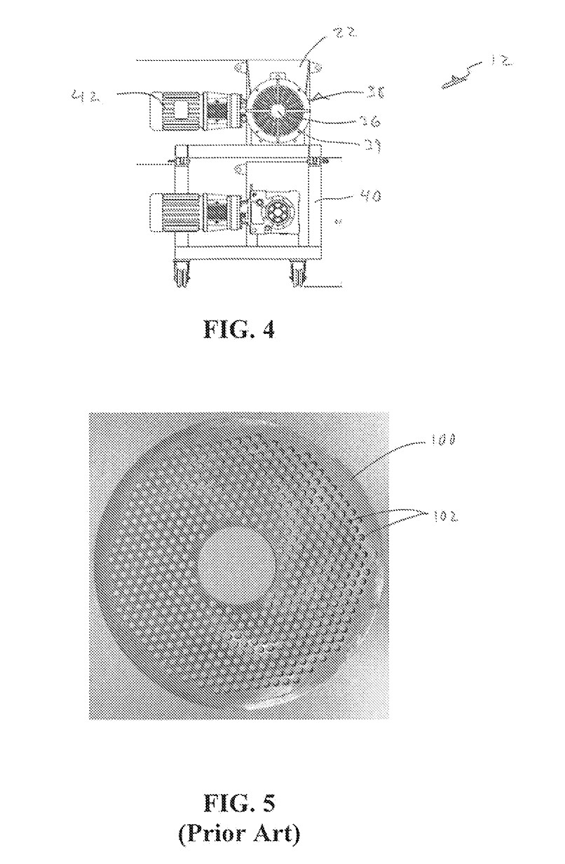

The ricer 12 shown in FIG. 1A is horizontally oriented. This type of ricer 12 is shown in more detail in FIGS. 2-4. It is to be appreciated that FIGS. 2-4 show a ricer system having a pair of ricer devices 12 mounted one above the other on a common frame 40 and oriented in opposite directions. This is only one of many possible configurations for ricer systems. Moreover, while the figures and description that follows reference only one of these two devices, it is to be understood that the two ricer devices can be configured alike, and, though not shown, can be used simultaneously with separate product input and discharge devices (e.g. conveyors). The ricer 12 generally includes an inlet 22 at its proximal end 30, an axially rotatable horizontal auger 32 to carry the unmashed product forward within the ricer 12, an auger housing 34 surrounding the auger, and a ricer plate 36 at the distal or discharge end 38 of the ricer housing 34. The inlet 22 can be a hopper configured for receiving unmashed potato pieces 18 discharged from the product feed device 14. The auger 32 includes spiral flights 33, and operates as a pumping mechanism that drives the unmashed potato pieces 18 through the holes in the ricer plate 36 to impart shear forces that have the effect of breaking up the potato chunks, thus forcing the potato pieces through the distal end 38 of the ricer 12 and producing the mashed product 26, which falls onto the product discharge device 16, to be delivered to the downstream processing devices 20.

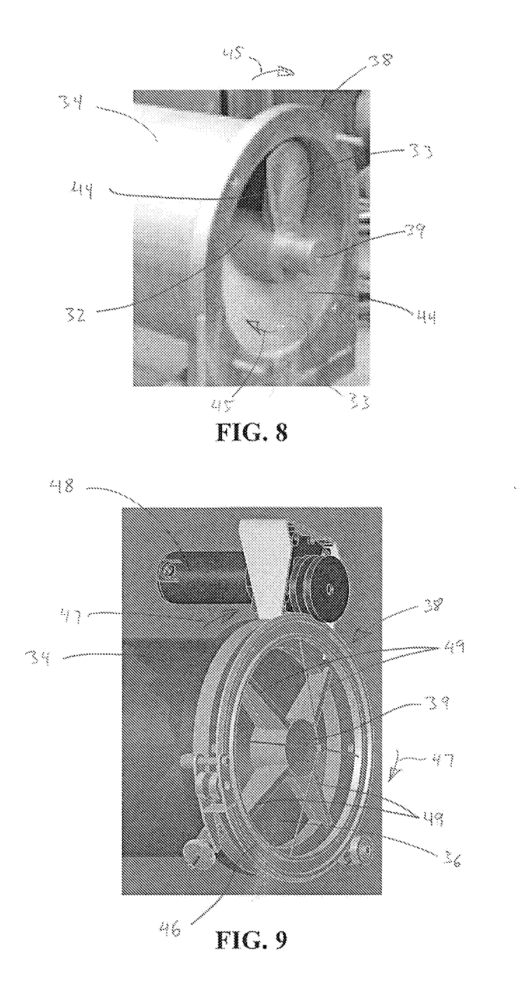

The auger 32 has a rotational axis that is generally aligned with the center of the ricer plate 36. The distal end 38 of the ricer 12 can also include an auger support bearing 39, which rotatably supports the distal end of the auger 32. As shown in FIG. 8, the free distal end 44 of the spiral flights 33 at the distal end of the auger 32 presses against the inside surface of the ricer plate 36 and act as a scraper, pressing the chunks of unmashed product 18 into and through the ricer plate 36 as the auger 32 rotates about its axis, as indicated by arrow 45 in FIG. 8. The ricer 12 can also include a cutoff wheel 46, disposed near or against the outside surface of the ricer plate 36 at the discharge end 38, as shown in FIG. 9. The cutoff wheel 46 has radial blades or spokes 49, and rotates in the direction indicated by arrows 47. With this motion, the cutoff wheel 46 cuts strands of potato mash and peel after the mash emerges from the ricer plate 36.

The cutoff wheel 46 can be disposed with its blades or spokes 49 pressed against the outside surface of the ricer plate 36, or it can be positioned some distance from the ricer plate, such as up to 1″ to 2″ or more. For example, in the vertically oriented ricer system 50, shown in FIG. 1B, the cutoff wheel 46 can be at any distance below the ricer plate 76, so long as it is above the product discharge device 16. However, in the horizontally oriented ricer system 10 of FIG. 1A, the cutoff wheel 46 is positioned close enough to the ricer plate 36 to intercept mashed product 26 before it falls to the discharge device 16.

As shown in FIGS. 1A, 1B and 9, the cutoff wheel 46 can have its own drive motor 48 to drive at its own rate, if desired, independent of the rate of rotation of the auger 32. Additionally, the cutoff wheel 46 can be driven in a direction opposite to the direction of rotation of the auger 32, in a manner that allows the production of potato mash pieces of varying size. Indeed, adjustment of the speed of the cutoff wheel 46 can control the length of the mash pieces regardless of the direction of rotation of the cutoff wheel 46. Additionally, higher speed of the cutoff wheel 46 relative to the auger 32 can help improve the spread of mashed product 26 on the discharge device 16.

Referring again to FIGS. 2-4, the ricer 12 can be mounted on a frame 40, which can be a mobile frame, allowing the ricer 12 to be moved to different locations within a food processing plant. The frame also supports a drive motor 42, which drives the axial rotation of the auger 32. Other features that would be apparent to one of skill in the art can also be associated with the ricer 12.

While the ricer 12 shown in FIG. 1A is horizontally oriented, other configurations can also be used. Shown in FIG. 1B is another embodiment of a ricing system 50 in which the ricer 52 is vertically oriented. The ricing system 50 is generally similar to the ricing system 10 of FIG. 1A, except that the ricer or ricing machine 52 is vertically oriented and the ricer plate 76 is horizontally oriented, and located above the product discharge device 16. This system 50 includes a vertically oriented ricer 52, positioned downstream of a product feed device 14, such as a conveyor, and upstream of a product discharge device 56, which can be another conveyor. The product feed device 14 brings unmashed product 18 from an upstream processing system 20, and discharges the product into an inlet 62 of the ricing machine. The product discharge device 16 delivers the mashed product 26 to one or more downstream processing devices, indicated generally at 28.

The ricer 52 shown in FIG. 1B is vertically oriented, and its inlet hopper 62 is configured slightly differently than the inlet hopper 22 of the ricer of FIGS. 1A and 2-4. Otherwise this ricer 52 is substantially the same as the horizontal ricer 12. The ricer 52 includes an axially rotatable auger 72 with spiral flights that carry the unmashed product 18 downward within the ricer 52, an auger housing 74 surrounding the auger, and a ricer plate 76 at the distal or discharge end 78 of the ricer housing 74. The ricer 52 includes an auger drive motor 42 for driving the auger 72, and a cutoff wheel drive motor 48 for driving a cutoff wheel (not shown in FIG. 1B). One desirable characteristic of the vertical configuration of FIG. 1B is that individual pieces of the mashed product 26 will land on the discharge device 16 without landing atop other pieces of mashed product 26, which can help to spread the product thinly on the discharge device 16. This helps keep particles of wet mash from combining into larger particles, which helps promote faster dehydration and/or freezing.

Ricer systems have traditionally used ricer plates with round holes. Shown in FIG. 5 is a conventional ricer plate 100 with a plurality of round holes 102. The auger and auger housing of a typical ricer device commonly have an inner diameter of about 12″ to 18″, which also defines the diameter of the discharge end of the ricer, and thus the overall diameter of the ricer plate. Thus, the ricer plate 100 of FIG. 5 can have a diameter of about 12″ to 18″, with a diameter of 12.75″ being common. The ricer plate 100 also includes a central aperture 104, which is provided for fitting over an end bearing of the auger (39 in FIG. 2).

The prior art ricer plate 100 shown in FIG. 5 includes circular holes 102. These holes 102 typically have a diameter of about 0.25″. As noted above, it has been found that mash that includes peel is very difficult to pump through a ricer with circular holes in this size range. The round holes tend to blind off and fail when ricing peel-in mash. Holes that are small enough to produce reasonably smooth mash are significantly smaller than a desired peel size for “homestyle” mashed potatoes with peel. If the holes are made of a larger diameter, to accommodate the peel chunks, they will not adequately mash the potato starch. The flat pieces of peel are too thin to be pressed through by the internal scraper. With a ricer plate having suitably small holes, the peel tends to plug the holes very quickly. As the holes plug, throughput decreases, pressure inside the ricer increases, and the auger overworks the potato pieces, thus adversely affecting the texture and quality of the mash product. While this plugging problem has often been addressed by frequently removing the ricer plate and either scraping it or turning it over, such frequent maintenance involves significant manual labor and system downtime.

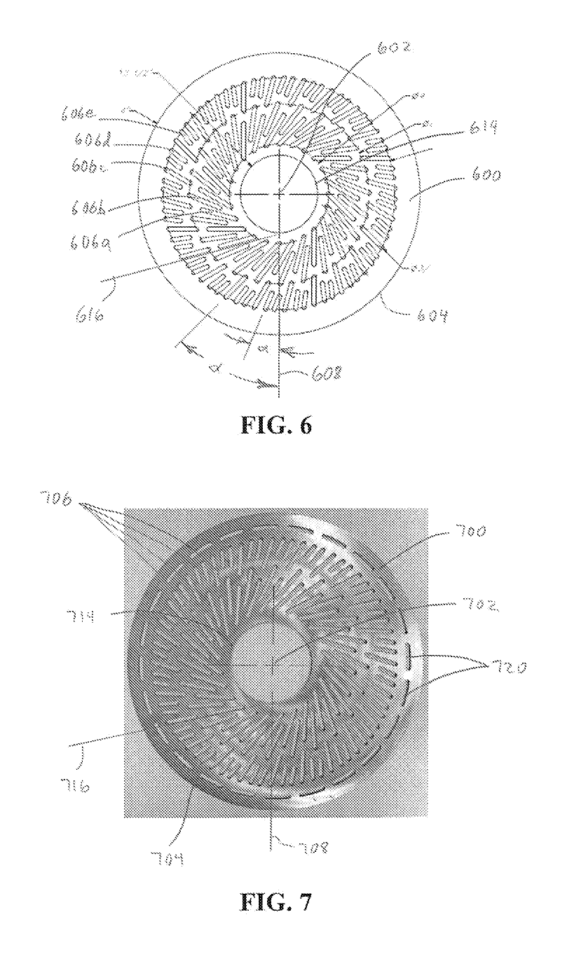

Advantageously, as disclosed herein, a ricing system and method have been developed that employs a slotted ricer plate, which can reliably produce potato mash with potato peel chunks, without suffering from the problems of clogging and jamming that prior ricer plates have. One embodiment of a slotted ricer plate 600 in accordance with the present disclosure is shown in FIG. 6. The ricer plate 600 is a substantially planar plate of strong material, such as food grade stainless steel, having a thickness of from about 0.2″ to 0.4″. Other materials can also be used, and it will be apparent that the thickness of the ricer plate 600 will depend upon the structural characteristics of the material from which the plate is made. In the embodiment of FIG. 6, the ricer plate 600 is circular, with a center, indicated at 602, and a perimeter edge, indicated at 604. The diameter of this ricer plate 600 is 12.75″. Other size ricer plates can be used, such as from 12″ to 24″ diameter. Moreover, ricer plates can be configured in shapes other than circular, if desired.

The ricer plate 600 includes a plurality of substantially linear, elongate slots, indicated generally at 606, which extend through the thickness of the plate 600. The slots 606 are generally radially symmetrically oriented. They are generally long and narrow, and are almost radial in orientation, but are slanted at an angle α relative to a radial line 608 extending from the center of the plate. This angle α can be selected to provide sufficient shear between the potato mash and the scraper end of the auger (44 in FIG. 8) and the cutoff wheel (46 in FIG. 9), if any. It is believed that the angle α can be anywhere from 0° to 90°, though angles between those extremes may be desirable.

In some embodiments it is considered desirable that the slot angle α relative to the radial line 608 be greater than zero. Having a non-zero angle α reduces the chance of the internal scraper (44 in FIG. 8) catching on a slot, thus potentially damaging the scraper or ricer plate, and potentially introducing foreign material (e.g. metal) into the product flow. At 0° the slot edges and scraper 44 will be parallel, which increases the probability of the scraper hanging up on a slot.

At the other extreme, it is believed that potato peel pieces may have less tendency to pass through the slots 606 if the slots are angled at 90°. Having an angle α that is greater than 0° and less than 90° produces a scissor action between the scraper 44 and slot edges. This helps push peel through the nearly radial slots because passing over the slot edge, as peel pieces must at lesser angles, helps the peel make the turn and pass through the ricer plate 36. Thus, the angle α generally can be from 0° to 90°. More specifically, the angle α can range from 9° to 45°; from 8° to 45°; from 7° to 45°; from 6° to 45°; from 5° to 45°; from 9° to 50°; from 8° to 50°; from 7° to 50°; from 6° to 50°; and more particularly from 10° to 45°. It has been found that angles α of from 10° to 45° work very well, and produce the desired scissor action, though other angular ranges can also be used. As can be seen in FIG. 6, the various slots 606 can be arranged at multiple different angles α on a single ricer plate 600. Additional benefits of this angle are discussed below.

There are some additional possible options for producing the desired angle α between the scraper 44 and the slots 606. For example, the slots 606 could be oriented at 0° (i.e. exactly radial), while the scraper 44 is oriented at some non-radial angle, thus still producing the desired scissor action. As another alternative, the slots 606 could be oriented at 0° (or some other angle) while the scraper 44 is curved, such as in a spiral shape. In this configuration, the angle α between a given slot 606 and the scraper 44 will vary depending upon the point of intersection of the scraper 44 along the slot 606. Other configurations are also possible.

As shown in FIG. 6, the presumed direction of rotation of the scraper (44 in FIG. 8) relative to the orientation of the slots 606 is indicated by arrow 610. This produces a scissor action between the scraper and the edge of the slots 606 to enhance passing the peel. Similarly, the individual blades or spokes of the cutoff wheel (46 in FIG. 9) are generally radially oriented, and will also provide this scissor action to cut chunks of mash from the outside of the ricer plate 600. For a given angular orientation of the slots 606, the ricer plate will have a designated inside surface and outside surface, and the ricer system will be intended to operate with the ricer plate oriented in this way. However, the system can function if the ricer plate is installed inside-out at the end of the ricer housing, because the angle between the scraper and the slots will still provide the desired scissor action, even when the plate is reversed. However, in such an arrangement, any peel that does not pass through the slots will tend to be driven toward the center of the ricer by the angle of the slots, and this raises the possibility that the ricer plate can plug up or “blind off”, since the center of the ricer plate includes no openings or slots. This condition could be addressed by the provision of arcuate circumferential slots near the center of the ricer plate, similar to those perimeter slots shown in FIG. 7 and discussed below, to allow the passage of peel that does not pass through the elongate slots 606.

The slots 606 have a width of at least about 1/10 inch and a length that is at least about three times the width. The length of the slots 606 allows thin, flat pieces of potato peel to pass through, while the narrower width provides sufficient shear to break up the potato chunks and mash the potato starch. In this way the slots 606 are suitably shaped to pass a portion of potato peel with the potato starch. In one specific embodiment, a ricer plate 600 has been produced and tested having slots that are 0.1875″ wide and 0.5″ to 1.75″ long. Other dimensions for the slots 606 can also be used. For example, it is believed that slots 606 having a width from 0.125″ (⅛″) to 0.25″ (¼″) can be suitable to provide sufficient shear to break down the potato chunks without over-shearing the product and producing a pasty texture. It is believed that the length of the slots 606 should be greater than 0.25″ in order to pass the peel, with a minimum length of about 0.5″ being likely.

The slots 606 can be arranged in various ways on the ricer plate 600. As shown in FIG. 6, the slots 606 can be arranged in multiple groups of different lengths or alternating lengths. For example, the plurality of slots 606 of the ricer plate 600 of FIG. 6 are generally radially symmetrically oriented, and are arranged in multiple groups of slots. The slots 606 of each group can have a unique length that is different from a length of the slots of at least one other group. For example, in the embodiment of FIG. 6, the slots 606 are of four different lengths, and are arranged in five different alternating locations. That is, there are two rings of alternatingly positioned inner slots 606a, b, the slots of these two different inner groups having a common length, and an alternating pattern of three different length slots 606c, d, e around an outer portion (i.e. closer to the perimeter 604) of the ricer plate 600. In this embodiment the inner slots 606a, b have a length of 1.75″, while the longest outer slots 606c have a length of 1.375″ and the shorter outer slots 606d, e have lengths of 1.0″ and 0.875″, respectively. The distance between adjacent slots 606 is generally a function of the mechanical strength and dimensions of the ricer plate 600. Where the ricer plate is of a stronger or thicker material, or is smaller in overall size, the slots 606 can be closer together than otherwise. In one embodiment, a stainless steel ricer plate 600 having a diameter of 12.75″ and a thickness of 0.2″ has been used with a minimum space of about 0.2″ between adjacent elongate slots 606.

The ricer plate 600 also includes a circular aperture 614 in the center of the circular plate 600, for accommodating a distal end bearing of the auger, as discussed above. In the embodiment of FIG. 6, the angle α of the linear slots 606 is selected such that each linear slot 606 is generally oriented along a line 616 that is tangent to the perimeter of the circular aperture 614. As can be seen in FIG. 6, multiple slots 606 can be sequentially positioned along any given tangent line 616.

While the slots 606 in the ricer plate 600 of FIG. 6 are substantially straight and linear, it is believed that these slots could also be slightly curved. For example, it is believed that slots of this general size and shape having a curvature of up to about 30° could be used without hindering their function. Thus, as used herein, the term “substantially straight” or “substantially linear” or similar terms having reference to the geometry of the elongate slots is intended to mean slots having a curvature of no more than 30°. The provision of curved slots would provide a variable angle scissor action, much in the same way having a curved scraper 44 against radial slots would do, as discussed above.

A ricer plate in accordance with the present disclosure can also include a set of circumferential slots near its perimeter. Shown in FIG. 7 is an embodiment of a slotted ricer plate 700 having circumferential slots 720 in accordance with the present disclosure. As with the embodiment of FIG. 6, the ricer plate 700 is a substantially planar plate of strong material, having a center, indicated at 702, a perimeter edge 704, and a circular aperture 714 in the center 702 of the plate. The ricer plate 700 includes an array of generally radially symmetrically oriented, nearly radial, substantially linear, elongate slots 706, which extend through the thickness of the plate 700, and are otherwise configured in the manner discussed above. These nearly radial slots 706 can be arranged in multiple groups of different lengths or alternating lengths. These generally radial slots 706 are generally oriented at an angle to a radial line 708, as discussed above. In one embodiment the angle is selected such that the elongate slots are oriented along lines 716 that are tangent to the perimeter of the circular central aperture 714, as discussed above.

Disposed near the perimeter edge 704 of the ricer plate 700 are a plurality of arcuate slots 720, generally arranged in a ring surrounding all of the substantially linear inner slots 706. Each arcuate slot 720 is curved about the center 702 of the ricer plate 700, thus being a circumferential slot. The width and length of these arcuate slots 720 conforms to the length and width characteristics discussed above for the inner slots 706. That is, each arcuate slot 720 can have a width of 0.125″ to 0.25″ and a length of from 0.875″ to 1.75″. The arcuate slots 720 help to pass any potato peel pieces that get pushed toward the perimeter or edge of the ricer plate by the action of the scraper end of the auger (44 in FIG. 8). As discussed above, the intended installation of the ricer plate orients the elongate slots 706 to provide the desired scissor action, and so that any peel that does not pass through the elongate slots 706 will be pushed toward the perimeter of the ricer plate 700, and thus toward the circumferential arcuate slots 720. This helps to pass all peel pieces and prevent plugging of the ricer plate 700. As noted above, circumferential arcuate slots, like the arcuate slots 720, could also be provided near the central region of the ricer plate 700, to allow the ricer plate to function and effectively pass peel pieces if it were installed inside-out.

With a ricer system using a slotted ricer plate in accordance with the present disclosure, a user can efficiently perform a method for producing potato mash with peel. The ricer system presses cooked potato pieces, including potato starch and potato peel, through the plurality of substantially linear, elongate slots of the ricer plate, such that the slots substantially mash the potato starch and pass the potato peel with the potato starch. As used herein, the term “substantially mash” or similar terms are intended to mean that the starch portion of the mashed product (26 in FIG. 1) has no lumps that are larger than 0.10″ in maximum dimension. Those of skill in the art will be aware that potato starch is composed of starch cells, which are separated from each other into smaller and smaller groups of starch cells using shear forces in a potato mashing process. However, if too much shear is applied, individual potato starch cells themselves can be broken, causing the potato mash to become pasty or sticky.

The slots are aligned at an angle relative to a radial line extending from the center of the ricer plate. In one embodiment, this angle is selected such that the elongate slots are parallel to a line tangent to a central aperture in the ricer plate. In one embodiment of the disclosed system, pressing the cooked potato pieces through the elongate slots of the ricer plate involves pumping them against the inside surface of the ricer plate with a rotating auger having a rotational axis that is aligned with the center of the ricer plate. This can involve pressing the potato pieces into the elongate slots of the ricer plate with a scraper, rotatably disposed against the inside surface of the ricer plate.

Pressing the cooked potato pieces through the elongate slots can also involve pressing the cooked potato pieces through a plurality of arcuate slots, disposed near a perimeter of the ricer plate and surrounding all of the elongate slots. Each of these arcuate slots can be curved about the center of the ricer plate and have size characteristics as described above. The method can also involve cutting off potato mash that emerges from the elongate slots of the ricer plate with a cutting wheel, disposed near or against an outside surface of the ricer plate.

Although various embodiments have been shown and described, the present disclosure is not so limited and will be understood to include all such modifications and variations are would be apparent to one skilled in the art.

What is claimed is:

1. A ricer plate for use in a ricing system configured for forcing cooked potato pieces, including potato peel and potato starch, against and through the plate, comprising:
a plate, having a thickness, a center and a perimeter; and
a plurality of substantially linear, elongate slots, extending through the thickness of the plate, each slot being aligned at an angle relative to a radial line extending from the center, and having a width of at least about 1/10 inch and a length that is at least about three times the width, the slots being suitably shaped to pass a portion of potato peel with the potato starch.

2. A ricer plate in accordance with claim 1, wherein each of the slots has a width of about ⅛ inch to ¼ inch, and a length of at least about ½ inch.

3. A ricer plate in accordance with claim 2, wherein each slot has a length of from ½ inch to 1¾ inches.

4. A ricer plate in accordance with claim 1, further comprising a circular central region of the circular plate, having a perimeter, at least some of the linear slots being oriented along a line tangent to the perimeter of the circular central region.

5. A ricer plate in accordance with claim 1, wherein the elongate slots are aligned at an angle of from 10° to 45° relative to the radial line.

6. A ricer plate in accordance with claim 1, wherein the plurality of slots are radially symmetrically oriented and comprise multiple groups of slots of a common length, the slots of each group having a unique length different from a length of at least one other group.

7. A ricer plate in accordance with claim 1, further comprising a plurality of circumferential arcuate slots, disposed near the perimeter of the plate and surrounding all of the substantially linear slots, each circumferential arcuate slot having a length of from ½″ to 1¾″.

8. A ricer plate in accordance with claim 1, wherein the circular plate has a diameter of from 12″ to 18″.

9. A potato ricing system, comprising:
a ricing machine, having a distal end, a proximal end with an inlet, and a pumping mechanism disposed between the proximal end and the distal end, the inlet configured to receive potato pieces including potato starch and potato peel, and the pumping mechanism configured to force the potato pieces to discharge through the distal end; and
a ricer plate, disposed at the distal end, having an inside surface and an outside surface, a center, a perimeter, and a plurality of substantially linear, elongate slots, extending from the inside surface to the outside surface, each slot being aligned at an angle relative to a radial line extending from the center, and having a width of at least about 1/10 inch and a length that is at least about three times the width, the elongate slots simultaneously passing the potato peel and converting the potato starch substantially to potato mash under pressure from the pumping mechanism.

10. A ricing system in accordance with claim 9, further comprising a distal end of the pumping mechanism contacting the inside surface of the ricer plate, configured to scrape the inside surface to press the potato pieces into the slots of the ricer plate.

11. A ricing system in accordance with claim 10, further comprising a cutoff wheel, disposed near the outside surface of the ricer plate, configured to cut strands of potato mash from the ricer plate as the mash emerges from the elongate slots.

12. A ricing system in accordance with claim 9, wherein the pumping mechanism comprises an auger, having a rotational axis aligned with the center of the ricer plate and a distal support coincident with the center of the ricer plate, the ricer plate having a central aperture with a perimeter, the central aperture surrounding the distal support of the auger, each linear slot of the ricer plate being oriented at an angle of from 10° to 45° relative to the radial line.

13. A ricing system in accordance with claim 9, wherein each of the elongate slots of the ricer plate have a width of about ⅛ inch to ¼ inch, and a length of about ½ inch to about 1¾ inches.

14. A ricing system in accordance with claim 9, further comprising a plurality of circumferential arcuate slots, disposed near the perimeter of the ricer plate and surrounding all of the substantially linear slots, each circumferential arcuate slot having a length of from ½″ to 1¾″.

15. A ricing system in accordance with claim 9, wherein the ricing machine is vertically oriented, and the ricer plate is horizontally oriented at the distal end.

16. A method for producing potato mash with peel, comprising:
pressing cooked potato pieces, including potato starch and potato peel, through a plurality of substantially linear, elongate slots of a ricer plate, the slots being aligned at an angle relative to a radial line extending from a center of the ricer plate, and having a width of at least about 1/10 inch and a length that is at least about three times the width, whereby the slots substantially mash the potato starch and pass the potato peel with the potato starch.

17. A method in accordance with claim 16, wherein pressing the cooked potato pieces through the elongate slots of the ricer plate comprises pumping the potato pieces against an inside surface of the ricer plate with a rotating auger having a rotational axis that is aligned with the center of the ricer plate.

18. A method in accordance with claim 17, further comprising pressing the potato pieces into the elongate slots of the ricer plate with a scraper, rotatably disposed against the inside surface of the ricer plate.

19. A method in accordance with claim 16, further comprising pressing the cooked potato pieces through a plurality of circumferential arcuate slots, disposed near a perimeter of the ricer plate and surrounding all of the elongate slots, each arcuate slot having a length of from ½″ to 1¾″.

20. A method in accordance with claim 16, further comprising cutting off potato mash that emerges from the elongate slots of the ricer plate with a cutting wheel, disposed near an outside surface of the ricer plate.
